(19) United States
(12) Patent Application Publication
(10) Pub. No.: US 2023/0261320 A1
(43) Pub. Date: Aug. 17, 2023

(54) Elastic Polymer Solid Electrolyte Separator for a Lithium Metal Battery and Manufacturing Process

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 17/649,377

(22) Filed: Jan. 31, 2022

(51) Int. Cl. H01M 50/446; H01M 10/0525; H01M 50/403; H01M 4/66; H01M 4/505; H01M 4/525; H01M 4/58

(52) U.S. Cl. CPC H01M 50/446; H01M 4/505; H01M 4/525; H01M 4/662; H01M 4/5825; H01M 10/0525; H01M 50/403

(57) ABSTRACT

A lithium metal battery comprising a cathode, an anode, and an elastic polymer separator disposed between the cathode and the anode, wherein the elastic polymer separator comprises a high-elasticity polymer and the elastic polymer separator has a thickness from 50 nm to 100 µm and a lithium ion conductivity from 10⁻⁶ S/cm to 5 × 10⁻² S/cm at room temperature and the high elasticity polymer has a fully recoverable tensile strain from 2% to 1,000% when measured without any additive dispersed therein. Preferably, the high-elasticity polymer contains a lithium salt and/or a lithium-ion conducting additive dissolved or dispersed therein. Also provided is a process for producing the elastic polymer separator and a lithium metal battery.

### FIELD

The present disclosure relates to the field of rechargeable lithium metal battery and, in particular, to an anode-less rechargeable lithium metal battery having no lithium metal as an anode active material initially when the battery is made and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li₄.₄Si) as an anode active material. Hence, in general, rechargeable Li metal batteries have a significantly higher energy density than lithium ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990′s giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); No. 6,797,428 (Sept. 28, 2004); No. 6,936,381 (Aug. 30, 2005); and No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI— Li3PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); No. 7,282,296 (Oct. 16, 2007); and No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Solid electrolytes typically have a low lithium ion conductivity, are difficult to produce and difficult to implement into a battery.

Furthermore, a solid-state electrolyte-based separator or an anode-protecting layer (interposed between the lithium film and a separator) does not have and cannot maintain a good contact with the lithium metal. This effectively reduces the effectiveness of the electrolyte to support dissolution of lithium ions (during battery discharge), transport lithium ions, and allowing the lithium ions to re-deposit back to the lithium anode (during battery recharge) in a homogeneous manner (to prevent lithium dendrite formation). A ceramic separator that is disposed between an anode active material layer (e.g., a lithium metal layer) and a cathode active layer suffers from the increased interfacial resistance due to poor electrolyte-electrode contacts. Normally, an excessively high holding pressure has to be exerted to the battery cell or module when a solid-state electrolyte is used.

Another major issue associated with the lithium metal anode is the continuing reactions between electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium metal cell that exhibits a high specific capacity, high specific energy, high degree of safety, and a long and stable cycle life.

### SUMMARY

The present disclosure provides a lithium metal battery comprising a cathode, an anode, and an elastic polymer separator disposed between the cathode and the anode, wherein the elastic polymer separator comprises a high-elasticity polymer and the elastic polymer separator has a thickness from 50 nm to 100 µm (preferably from 1 to 20 µm) and a lithium ion conductivity from 10⁻⁶ S/cm to 5 × 10⁻² S/cm at room temperature and the high elasticity polymer has a fully recoverable tensile strain from 2% to 1,000% (preferably greater than 10% and further preferably from 30% to 300%) when measured without any additive dispersed therein.

In a typical configuration, the separator is in ionic contact with both the anode and the cathode and typically in physical contact with an anode active material layer (or an anode current collector) and with a cathode active material layer. The anode and/or the cathode may also contain a working electrolyte to facilitate lithium ion transport in the electrodes. Thus, a battery cell may further comprise, in addition to the elastic polymer separator serving as a solid electrolyte, a working electrolyte in ionic contact with an anode active material and/or a cathode active material wherein said working electrolyte is selected from an organic liquid electrolyte, ionic liquid electrolyte, polymer gel electrolyte, solid polymer electrolyte different than the high-elasticity polymer, inorganic solid electrolyte, quasi-solid electrolyte having a lithium salt dissolved in an organic or ionic liquid with a lithium salt concentration higher than 2.0 M (preferably from 2.5 M to 14 M), or a combination thereof.

In certain embodiments, the anode in the lithium secondary battery has an amount of lithium or lithium alloy as an anode active material supported by an anode current collector. In certain other embodiments, initially the anode has no lithium or lithium alloy as an anode active material supported by said anode current collector when the battery is made and prior to a charge or discharge operation of the battery. This latter configuration is referred to as an anode-less lithium metal battery.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

In certain embodiments, the high-elasticity polymer comprises an elastomer or rubber selected from natural polyisoprene, synthetic polyisoprene, polybutadiene, chloroprene rubber, polychloroprene, butyl rubber, poly(butyl diacrylate) rubber containing no dispersed plastic crystal, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene- styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof. These elastomers are primarily used for lithium metal batteries and lithium air batteries, but not including lithium-sulfur and lithium-selenium batteries.

In some embodiments, the high-elasticity polymer comprises an elastomer selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The elastic polymer separator may further comprise from 0.1% to 80% by weight of a lithium ion-conducting material dispersed or dissolved in the high-elasticity polymer. The lithium ion-conducting material may comprise a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

In some embodiments, the lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X = F, C1, I, or Br, R = a hydrocarbon group, x = 0-1, y = 1-4.

In certain embodiments, the high-elasticity polymer forms a mixture, blend, copolymer, crosslinked network, or interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

A high-elasticity polymer refers to a polymer, typically a lightly cross-linked polymer, which exhibits an elastic deformation that is at least 2% (preferably at least 5%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of inorganic filler is added into the polymer. Depending upon the type and proportion of the solid electrolyte particles incorporated, the reversible elastic deformation is typically reduced to the range of 2%-500%, more typically 2%-300%.

In some preferred embodiments, the high-elasticity polymer contains a lightly cross-linked network of polymer chains having an ether linkage, nitrile-derived linkage, benzo peroxide-derived linkage, ethylene oxide or ethylene glycol linkage (e.g., ethylene glycol diacrylate chains), propylene oxide linkage, vinyl alcohol linkage, cyano-resin linkage, acrylate linkage, triacrylate monomer-derived linkage, tetraacrylate monomer-derived linkage, a derivative thereof, or a combination thereof, in the cross-linked network of polymer chains having a degree of crosslinking that affords an elasticity of the polymer in the range from 5% to 1,000%. These network or cross-linked polymers exhibit a unique combination of a high elasticity (high elastic deformation strain) and high lithium-ion conductivity.

Acrylates include those shown in the following formula:

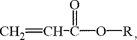

Examples of acrylate linkages include those derived from methyl acrylate, ethyl acrylate, propyl acrylate, n-butyl acrylate, isobutyl acrylate, n-pentyl acrylate, isoamyl acrylate, n-hexyl acrylate, 2-methylpentyl acrylate, n-octyl acrylate, 2-ethylhexyl acrylate, n-decyl acrylate, n--dodecyl acrylate, n-octadecyl acrylate, and the like; methoxymethyl acrylate, methoxyethyl acrylate, ethoxyethyl acrylate, butoxyethyl acrylate, ethoxypropyl acrylate, methylthioethyl acrylate, hexylthioethyl acrylate, and the like; and α, β-cyanoethyl acrylate, α, β and γ-cyanopropyl acrylate, cyanobutyl acrylate, cyanohexyl acrylate, cyanooctyl acrylate, and the like, besides mixtures thereof. R is preferably an alkyl radical containing from 1 to 10 carbon atoms, or an alcoxyalkyl radical containing from 2 to 8 carbon atoms. Examples of the most preferred acrylates are ethyl acrylate, propyl acrylate, n-butyl acrylate, hexyl acrylate, 2-ethylhexyl acrylate, octyl acrylate, methoxyethyl acrylate and ethoxyethyl acrylate.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, poly(ethylene glycol) diacrylate (PEGDA) chains, acrylic acid-derived chains, polyvinyl alcohol chains, or a combination thereof.

In certain desired embodiments, the high-elasticity polymer in the separator comprises from 5% to 95% by weight (preferably from 25% to 75%, more preferably from 35% to 65%, and most preferably from 45% to 55%) of a lithium ion-conducting plastic crystal or organic domain phase dispersed in or connected to the high-elasticity polymer. Preferably, the high-elasticity polymer and the plastic crystal phase or organic domain form co-continuous phases exhibiting a lithium-ion conductivity no less than 10⁻⁵ S/cm. These high-elasticity polymers elastomers can be used for lithium metal batteries, lithium air batteries, lithium-sulfur batteries, and lithium-selenium batteries.

The plastic crystal or organic domain phase typically and desirably comprises a mixture of a lithium salt and a lithium ion conducting organic species. These organic species preferably have a relatively high dielectric constant (preferably > 5, more preferably > 20, and further preferably > 50) that is conducive to dissolving a suitable amount of a lithium salt. The mixture should also have chemical compatibility with the crosslinked network of chains of the elastic polymer and can be readily impregnate into the nano-scaled spaces between these chains. The organic species may be in the form of an oligomer or low molecular weight polymer having a number average molecular weight preferably less than 10,000 g/mole.

The desirable organic species in the plastic crystal/organic domain phase may be selected from a fluorinated carbonate, hydrofluoroether, fluorinated vinyl carbonate, fluorinated ester, fluorinated vinyl ester, fluorinated vinyl ether, sulfone, sulfide, nitrile, succino-nitrile, phosphate, phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, fluoroethylene carbonate (FEC), an ionic liquid solvent, a polymerized version thereof, or a combination thereof. The polymerized versions of these polymers preferably have a low molecular weight, having a number average molecular weight preferably less than 10,000 g/mole (more preferably < 5,000 g/mole and further more preferably < 2,000 g/mole).

The sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

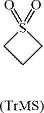

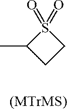

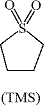

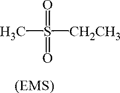

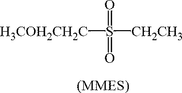

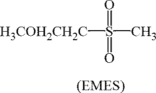

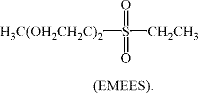

The vinyl sulfone or sulfide may be selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

The nitrile preferably comprises a dinitrile or is selected from AND, GLN, SEN, a combination thereof, or a combination thereof with succino-nitrile:

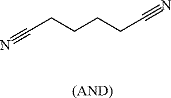

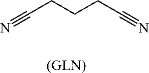

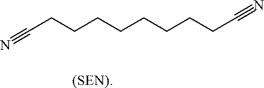

The phosphate may be selected from allyl-type, vinyl-type, styrenic-type and (meth)acrylic-type monomers bearing a phosphonate moiety. The phosphate, phosphonate, phosphonic acid, phosphazene, or phosphite may be selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae:

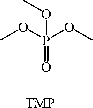

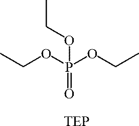

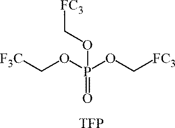

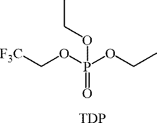

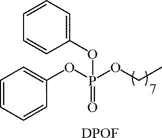

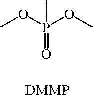

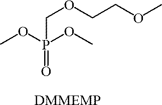

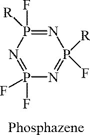

wherein R = H, NH₂, or C₁ -C₆ alkyl.

The siloxane or silane may be selected from alkylsiloxane (Si—O), alkyylsilane (Si—C), liquid oligomeric silaxane (—Si—O—Si—), or a combination thereof.

This high-elasticity polymer layer may be a thin film disposed against a surface of an anode current collector. The anode contains a current collector without a lithium metal or any other anode active material when the battery cell is manufactured. Such a battery cell having an initially lithium metal-free anode is commonly referred to as an “anode-less” lithium metal battery. The lithium ions that are required for shuttling back and forth between the anode and the cathode are initially stored in the cathode active materials (e.g., Li in LiMn₂O₄ and LiMPO₄, where M = Ni, Co, F, Mn, etc.). During the first battery charge procedure, lithium ions (Li⁺) come out of the cathode active material, move through the working electrolyte and then through the presently disclosed high-elasticity polymer separator layer, and get deposited on a surface of the anode current collector. As this charging procedure continues, more lithium ions get deposited onto the current collector surface, eventually forming a lithium metal film or coating.

During the subsequent discharge, this lithium film or coating layer decreases in thickness due to dissolution of lithium into the electrolyte to become lithium ions, creating a gap between the current collector and the protective layer if the protective layer were not elastic. Such a gap would make the re-deposition of lithium ions back to the anode impossible during a subsequent recharge procedure. We have observed that the high-elasticity polymer is capable of expanding or shrinking congruently or conformably with the anode layer. This capability helps to maintain a good contact between the current collector (or the lithium film itself) and the protective layer, enabling the re-deposition of lithium ions without interruption.

In certain embodiments, the high-elasticity polymer further contains a reinforcement material dispersed therein wherein the reinforcement material is selected from a polymer fiber, a glass fiber, a ceramic fiber or nano-flake (e.g., nano clay flakes), or a combination thereof. The reinforcement material preferably has a thickness or diameter less than 100 nm.

The cathode active material may be selected from an inorganic material, an organic material, a polymeric material, or a combination thereof. The inorganic material may be selected from a metal oxide, metal phosphate, metal silicide, metal selenide (e.g., lithium polyselides for use in a Li—Se cell), metal sulfide (e.g., lithium polysulfide for use in a Li—S cell), or a combination thereof. Preferably, these cathode active materials contain lithium in their structures; otherwise the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1 < x < 5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode may comprise a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, selected from a carbon material, graphene, electronically conductive polymer, conductive metal oxide, or conductive metal coating.

The disclosure also provides an anode electrode for use in a lithium metal battery, the anode comprising (a) an anode current collector and an optional lithium metal or lithium alloy supported on the anode current collector; and (b) a thin layer of a high-elasticity polymer (a solid polymer electrolyte) in contact with the anode current collector or the lithium metal or lithium metal alloy (when present) wherein the polymer has a thickness from 1 nm to 10 µm, a fully recoverable tensile strain from 2% to 500%, and a lithium ion conductivity from 10⁻⁶ S/cm to 5 × 10⁻² S/cm. A cathode layer may be brought to be in contact with this elastic separator layer to make a battery cell.

The disclosure also provides a process for manufacturing the elastic polymer separator, the process comprising (A) providing (i) a liquid polymer solution comprising a high-elasticity polymer dissolved in a liquid solvent or (ii) a liquid reactive mass as a precursor to a high-elasticity polymer; (B) dispensing and depositing a layer of the liquid solution or the liquid reactive mass onto a solid substrate surface; and (C) removing the liquid solvent from the liquid polymer solution to precipitate out the high-elasticity polymer or polymerizing and/or curing the reactive mass to form the layer of elastic polymer separator.

The liquid polymer solution or the liquid reactive mass comprises a lithium salt or a lithium ion-conducting material dissolved or dispersed therein.

The solid substrate may be an anode current collector, an anode active material layer, or a cathode active material layer. In other words, this elastic polymer separator can be directly deposited onto a layer of anode active material, an anode current collector, or a layer of cathode active material. This is achievable because curing of the high-elasticity polymer does not require a high temperature; curing temperature typically lower than 200° C. or even lower than 100° C. This is in stark contrast to the typically 900-1,200° C. required of sintering an inorganic solid electrolyte to form a ceramic separator. In addition, the presently disclosed elastic separator is at least as good as a ceramic separator in terms of reducing interfacial impedance and stopping dendrite penetration.

The process may be a roll-to-roll process wherein said step (B) comprises (1) continuously feeding a layer of the solid substrate from a feeder roller to a dispensing zone where the liquid polymer solution or the reactive mass is dispensed and deposited onto the solid substrate to form a continuous layer of the liquid polymer solution or the reactive mass; (2) moving the layer of the liquid polymer solution or the reactive mass into a reacting zone where the liquid polymer solution or the reactive mass is subjected to solvent removal or exposed to heat, ultraviolet light, or high-energy radiation to polymerize and/or cure the reactive mass to form a continuous layer of elastic polymer; and (3) collecting the elastic polymer on a winding roller.

If desirable, the resulting elastic polymer separator may be soaked in or impregnated with an organic or ionic liquid electrolyte.

The process may further comprise cutting and trimming the layer of elastic polymer into one or multiple pieces of elastic composite separators.

The process may further comprise combining an anode, the elastic polymer separator, an optional working electrolyte, and a cathode electrode to form a lithium battery.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell (upper diagram) containing an anode current collector (e.g., Cu foil) but no anode active material (when the cell is manufactured or in a fully discharged state), an elastic polymer separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the elastic polymer separator layer when the battery is in a charged state.

FIG. 3 Schematic of an elastic polymer separator layer wherein the plastic crystals or organic domains are uniformly dispersed in a matrix of high-elasticity polymer according to some embodiments of the present disclosure.

FIG. 4 Schematic of a roll-to-roll process for producing rolls of elastic composite separator in a continuous manner.

FIG. 5 Representative tensile stress-strain curves of lightly cross-linked ETPTA polymers.

### DETAILED DESCRIPTION

This disclosure is related to a lithium secondary battery. The shape of a lithium secondary battery can be cylindrical, square, button-like, etc. The present invention is not limited to any battery shape or configuration or any type of electrolyte.

The present disclosure provides a lithium metal battery comprising a cathode, an anode, and an elastic polymer separator (a solid-state electrolyte layer) disposed between the cathode and the anode, wherein the elastic polymer separator comprises a high-elasticity polymer and the elastic polymer separator has a thickness from 50 nm to 100 µm (preferably from 1 to 20 µm) and a lithium ion conductivity from 10⁻⁶ S/cm to 5 × 10⁻² S/cm at room temperature and the high elasticity polymer has a fully recoverable tensile strain from 2% to 1,000% (preferably greater than 10% and further preferably from 30% to 300%) when measured without any additive dispersed therein.

In a typical configuration, the separator is in ionic contact with both the anode and the cathode and typically in physical contact with an anode active material layer (or an anode current collector) and with a cathode active material layer. The anode and/or the cathode may also contain a working electrolyte to facilitate lithium ion transport in the electrodes. Thus, a battery cell may further comprise, in addition to the elastic polymer separator serving as a solid electrolyte, a working electrolyte in ionic contact with an anode active material and/or a cathode active material wherein said working electrolyte is selected from an organic liquid electrolyte, ionic liquid electrolyte, polymer gel electrolyte, solid polymer electrolyte different than the high-elasticity polymer, inorganic solid electrolyte, quasi-solid electrolyte having a lithium salt dissolved in an organic or ionic liquid with a lithium salt concentration higher than 2.0 M (preferably from 2.5 M to 14 M), or a combination thereof.

In certain embodiments, the anode in the lithium secondary battery has an amount of lithium or lithium alloy as an anode active material supported by an anode current collector. In certain other embodiments, initially the anode has no lithium or lithium alloy as an anode active material supported by said anode current collector when the battery is made and prior to a charge or discharge operation of the battery. This latter configuration is referred to as an anode-less lithium metal battery.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

In certain embodiments, the high-elasticity polymer comprises an elastomer or rubber selected from natural polyisoprene, synthetic polyisoprene, polybutadiene, chloroprene rubber, polychloroprene, butyl rubber poly(butyl diacrylate) rubber containing no dispersed plastic crystal, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

We have discovered that this elastic polymer layer provides several unexpected benefits: (a) the formation and penetration of dendrite can be essentially eliminated; (b) uniform deposition of lithium back to the anode side is readily achieved during battery charging; (c) the layer ensures smooth and uninterrupted transport of lithium ions to/from the anode current collector surface (or the lithium film deposited thereon during the battery operations) and through the interface between the current collector (or the lithium film deposited thereon) and the elastic polymer separator layer with minimal interfacial resistance; (d) the elastic polymer, having a high elasticity, is capable of accommodating the large volume expansion or shrinkage of the lithium metal layer during the charge and discharge of the lithium metal battery, reducing or eliminating the need to provide a high clamping pressure on the battery cell, module, or stack; and (e) cycle stability can be significantly improved and cycle life increased. No additional protective layer for the lithium metal anode is required. The separator itself also plays the role as an anode protective layer.

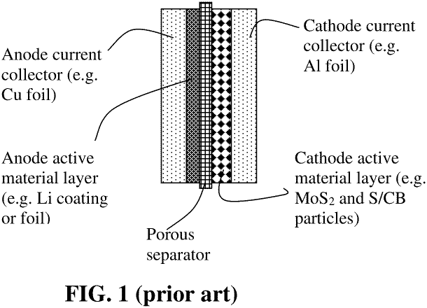

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium-air battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new elastic polymer separator disposed between the anode (an anode current collector or an anode active material layer) and a cathode active material layer. This elastic polymer separator layer comprises a high-elasticity polymer having a recoverable (elastic) tensile strain no less than 2% (preferably no less than 5%, and further preferably from 10% to 500%) under uniaxial tension and a lithium ion conductivity no less than 10⁻⁶ S/cm at room temperature (preferably and more typically from 1×10⁻⁵ S/cm to 5 ×10⁻² S/cm).

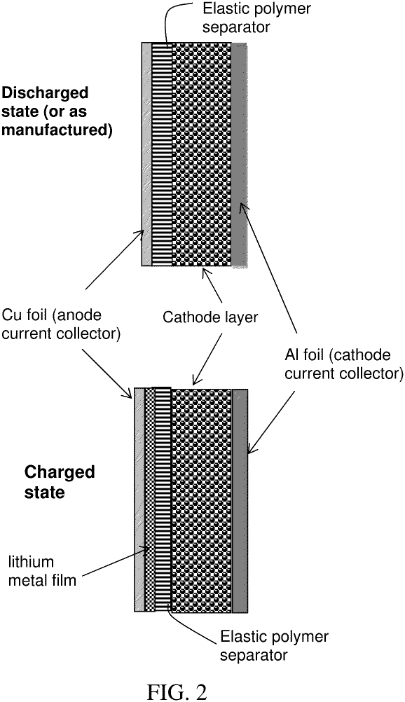

As schematically shown in FIG. 2, one embodiment of the present disclosure is a lithium metal battery cell containing an anode current collector (e.g., Cu foil), a high-elasticity polymer-based separator (a polymer solid-state electrolyte), and a cathode active material layer, which is composed of particles of a cathode active material, a conductive additive (not shown) and a resin binder (not shown). A cathode current collector (e.g., Al foil) supporting the cathode active layer is also shown in FIG. 2.

The high-elasticity polymer material refers to a material (polymer) that exhibits an elastic deformation of at least 5% when measured under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 5%, more preferably greater than 10%, further more preferably greater than 30%, and still more preferably greater than 100% (up to 500%).

It may be noted that FIG. 2 shows an example of a lithium metal battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of the lithium battery (e.g., as part of the electrochemical formation process), lithium comes out of the cathode active material, passes through the elastic polymer separator and deposits on the anode current collector. The presence of the presently invented high-elasticity polymer separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, creating a gap between the current collector and the protective layer if the separator layer were not elastic. Such a gap would make the re-deposition of lithium ions back to the anode challenging or impossible during a subsequent recharge procedure. We have observed that the elastic polymer separator layer is capable of expanding or shrinking congruently or conformably with the anode layer. This capability helps to maintain a good contact between the current collector (or the lithium film subsequently or initially deposited on the current collector surface) and the protective layer, enabling the re-deposition of lithium ions without interruption.

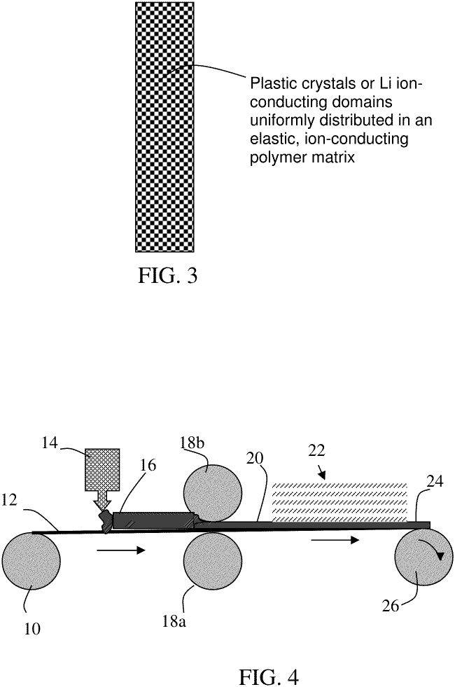

FIG. 3 schematically shows an elastic polymer separator layer wherein plastic crystals or ion-conducting domains are uniformly dispersed in a matrix of an elastic polymer according to some embodiments of the present disclosure. A plastic crystal or ionic conducting domain typically comprises an integrated mixture or complex of a lithium salt with either a plastic crystal or organic species that help to hold the lithium salt together to form a domain. Such a plastic crystal or domain naturally resides in interstices between chains of an elastic polymer. This phase typically has a lithium ion conductivity higher than the high-elasticity polymer. Hence, this plastic crystal or ion-conducting domain phase imparts lithium ion conductivity to the high-elasticity polymer and the high-elasticity polymer provides the desired mechanical flexibility to the battery cell.

In some embodiments, the high-elasticity polymer comprises an elastomer selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The elastic polymer separator may further comprise from 0.1% to 50% by weight of a lithium ion-conducting material dispersed or dissolved in the high-elasticity polymer. The lithium ion-conducting material may comprise a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

In some embodiments, the lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X = F, Cl, I, or Br, R = a hydrocarbon group, x = 0-1, y = 1-4.

In certain embodiments, the high-elasticity polymer forms a mixture, blend, copolymer, crosslinked network, or interpenetrating network (simultaneous or semi-interpenetrating network) with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

A high-elasticity polymer refers to a polymer, typically a lightly cross-linked polymer, which exhibits an elastic deformation that is at least 2% (preferably at least 5%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). Metals and plastics can be stretched beyond 2% or even beyond 100%, but these deformations are plastic deformations (permanent deformations) that are not recoverable upon release of the mechanical load.

The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of inorganic filler is added into the polymer. Depending upon the type and proportion of the additive incorporated, the reversible elastic deformation is typically reduced to the range of 2%-500%, more typically 2%-300%.

In some preferred embodiments, the high-elasticity polymer contains a lightly cross-linked network of polymer chains having an ether linkage, nitrile-derived linkage, benzo peroxide-derived linkage, ethylene oxide linkage, ethylene glycol linkage (e.g., ethylene glycol diacrylate chains), propylene oxide linkage, vinyl alcohol linkage, cyano-resin linkage, triacrylate monomer-derived linkage, tetraacrylate monomer-derived linkage, or a combination thereof, in the cross-linked network of polymer chains having a degree of crosslinking that affords an elasticity of the polymer in the range from 5% to 1,000%. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, poly(ethylene glycol) diacrylate (PEGDA) chains, acrylic acid-derived chains, polyvinyl alcohol chains, or a combination thereof.

In certain desired embodiments, the high-elasticity polymer in the separator comprises from 5% to 95% by weight (preferably from 25% to 75%, more preferably from 35% to 65%, and most preferably from 45% to 55%) of a lithium ion-conducting plastic crystal or organic domain phase dispersed in or connected to the high-elasticity polymer. Preferably, the high-elasticity polymer and the plastic crystal or organic domain phase form co-continuous phases exhibiting a lithium-ion conductivity no less than 10⁻⁵ S/cm.

The plastic crystal or organic domain phase typically and desirably comprises a mixture of a lithium salt and a lithium ion conducting organic species. These organic species preferably have a relatively high dielectric constant (preferably > 5, more preferably > 20, and further preferably > 50) that is conducive to dissolving a suitable amount of a lithium salt. The mixture should also have chemical compatibility with the crosslinked network of chains and can be readily impregnated into the nano-scaled spaces between these chains. The chains of the elastic polymer serve to hold the mixture in place.

The desirable organic species in the plastic crystal phase/organic domain may be selected from a fluorinated carbonate, hydrofluoroether, fluorinated vinyl carbonate, fluorinated ester, fluorinated vinyl ester, fluorinated vinyl ether, sulfone, sulfide, nitrile, succino-nitrile, phosphate, phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), fluoroethylene carbonate (FEC), an ionic liquid solvent, a polymerized version thereof, or a combination thereof. The polymerized versions of these polymers preferably have a low molecular weight, having a number average molecular weight, Mn, preferably less than 10,000 g/mole (more preferably < 5,000 g/mole and further more preferably < 2,000 g/mole).

The presence of this organic species is designed to impart certain desired properties to the polymer electrolyte, such as lithium-ion conductivity and flame retardancy. For instance, desirable organic species include fluorinated solvents that are preferable curable; e.g., fluorinated vinyl carbonates, fluorinated esters, fluorinated vinyl esters, and fluorinated vinyl ethers. Fluorinated vinyl esters include R_{f}CO₂CH═CH₂ and Propenyl Ketones, R_{f}COCH═CHCH₃, where R_{f} is F or any F-containing functional group (e.g., CF₂ - and CF₂CF₃-).

Two examples of fluorinated vinyl carbonates are given below:

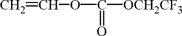

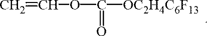

In some embodiments, the fluorinated carbonate is selected from fluoroethylene carbonate (FEC), DFDMEC, FNPEC, hydrofluoro ether (HFE), trifluoro propylene carbonate (FPC), or methyl nonafluorobutyl ether (MFE), wherein the chemical formulae for FEC, DFDMEC, and FNPEC, respectively are shown below:

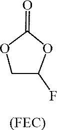

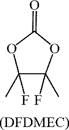

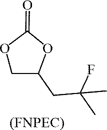

Desirable sulfones as a liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

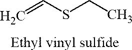

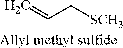

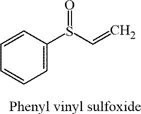

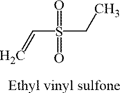

Ethyl vinyl sulfide Allyl methyl sulfide Phenyl vinyl sulfoxide Ethyl vinyl sulfone

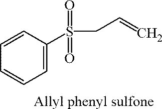

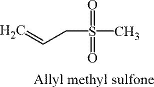

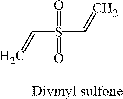

In certain embodiments, the sulfone as a liquid solvent is selected from TrMS, MTrMS, TMS, or vinyl or double bond-containing variants of TrMS, MTrMS, TMS, EMS, MMES, EMES, EMEES, or a combination thereof; their chemical formulae being given below:

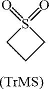

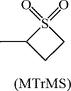

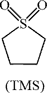

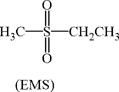

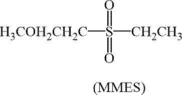

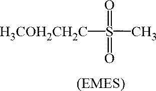

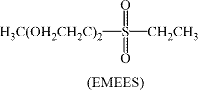

The nitrile as a liquid solvent or as an additive to a liquid solvent may be selected from a dinitrile, such as AND, GLN, SEN, or a combination thereof and their chemical formulae are given below:

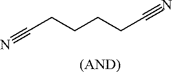

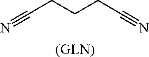

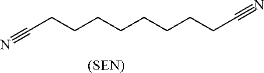

In some embodiments, the liquid solvent is selected from phosphate, alkyl phosphonate, phosphazene, phosphite, or sulfate; e.g., tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

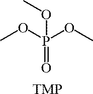

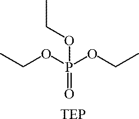

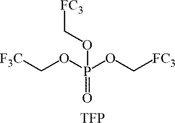

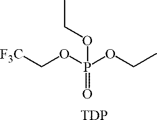

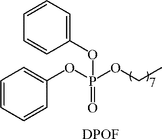

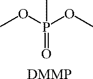

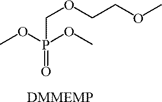

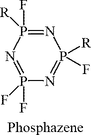

wherein R = H, NH₂, or C₁ -C₆ alkyl.

The disclosed organic species may be initially in a reactive liquid form that can be co-cured or co-polymerized with the precursor monomer/oligomer of an intended elastic polymer. The disclosed organic species may comprise a lithium salt and an initiator, a substituent, a comonomer, or a crosslinking agent dissolved or dispersed in a reactive liquid medium comprising a reactive elastomer precursor (monomer, oligomer, or reactive polymer). The organic species are then co-polymerized or co-cured with the elastomer, forming an intimate blend, co-polymer, interpenetrating network, etc.

Typically, a high-elasticity polymer is originally in a monomer or oligomer states that can be cured to form a cross-linked polymer that is highly elastic. Prior to curing, these polymers or oligomers are soluble in an organic solvent to form a polymer solution. An ion-conducting additive may be added to this solution to form a suspension. This solution or suspension can then be formed into a thin layer of polymer precursor on a surface of (i) an anode current collector, (ii) lithium metal layer, or (iii) cathode active material layer. The polymer precursor (monomer or oligomer and initiator) is then polymerized and cured to form a lightly cross-linked polymer. Alternatively, a thin layer of such an elastic polymer may be tentatively deposited on a solid substrate (e.g., surface of a polymer or glass), dried, and separated from the substrate to become a free-standing polymer layer. This free-standing layer is then laid on a lithium foil/coating (or anode current collector) and a cathode layer. Polymer layer formation can be accomplished by using one of several procedures well-known in the art; e.g., spraying, spray-painting, printing, coating, extrusion-based film-forming, casting, etc.

For instance, ethoxylated trimethylopropane triacrylate monomer (ETPTA, Mw = 428, chemical formula given below), along with an initiator, can be dissolved in an organic solvent, such as ethylene carbonate (EC) or diethyl carbonate (DEC). Then, the ETPTA monomer/solvent/initiator solution may be cast to form ETPTA a monomer/initiator layer on a glass surface. The layer can then be thermally cured to obtain a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

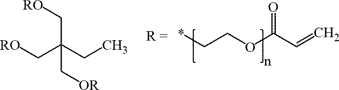

As another example, the high-elasticity polymer for anode lithium foil/coating protection may be based on cationic polymerization and cross-linking of the cyanoethyl polyvinyl alcohol (PVA-CN, Formula 2) in succinonitrile (SN).

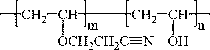

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, the solution may be deposited to form a thin layer of reacting mass, PVA-CN/LiPF₆, which is subsequently heated at a temperature (e.g., from 75 to 100° C.) for 2 to 8 hours to obtain a high-elasticity polymer. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc = pRT/Ge, where Ge is the equilibrium modulus as determined by a temperature sweep in dynamic mechanical analysis, p is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory’s Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range of 10⁻⁴ to 5 × 10⁻³ S/cm.

The aforementioned high-elasticity polymers may be used alone to serve as a separator layer. A broad array of elastomers can be used alone as an elastic polymer or mixed with a high-elasticity polymer to form a blend, co-polymer, or interpenetrating network that encapsulates the cathode active material particles.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

Unsaturated rubbers that can be used as an elastic polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g., by having a copolymer domain that holds other linear chains together. Each of these elastomers can be used to bond particles of a cathode active material by one of several means; e.g., spray coating, dilute solution mixing (dissolving the cathode active material particles in an uncured polymer, monomer, or oligomer, with or without an organic solvent) followed by drying and curing.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g., urea-urethane copolymer) are particularly useful elastomeric shell materials for encapsulating anode active material particles.

The presently invented lithium secondary batteries can contain a wide variety of cathode active materials. The cathode active material layer may contain a cathode active material selected from an inorganic material, an organic material, a polymeric material, or a combination thereof. The inorganic material may be selected from a metal oxide, metal phosphate, metal silicide, metal selenide, transition metal sulfide, or a combination thereof.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1 < x < 5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

There are a wide variety of processes that can be used to produce layers of elastic polymer separators. These include coating, casting, painting, spraying (e.g., ultrasonic spraying), spray coating, printing (screen printing, 3D printing, etc.), tape casting, etc.

The disclosure also provides a process for manufacturing the elastic polymer separator, the process comprising (A) providing (i) a liquid polymer solution comprising a high-elasticity polymer dissolved in a liquid solvent or (ii) a liquid reactive mass as a precursor to a high-elasticity polymer; (B) dispensing and depositing a layer of the liquid solution or the liquid reactive mass onto a solid substrate surface; and (C) removing the liquid solvent from the liquid polymer solution to precipitate out the high-elasticity polymer or polymerizing and/or curing the reactive mass to form the layer of elastic polymer separator.

The liquid polymer solution or the liquid reactive mass comprises a lithium salt or a lithium ion-conducting material dissolved or dispersed therein.

The solid substrate may be an anode current collector, an anode active material layer, or a cathode active material layer. In other words, this elastic polymer separator can be directly deposited onto a layer of anode active material, an anode current collector, or a layer of cathode active material. This is achievable because curing of the high-elasticity polymer does not require a high temperature; curing temperature typically lower than 200° C. or even lower than 100° C. This is in stark contrast to the typically 900-1,200° C. required of sintering an inorganic solid electrolyte to form a ceramic separator. In addition, the presently disclosed elastic separator is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation to polymerize and/or cure the reactive mass to form a continuous layer of elastic polymer; and (iii) collecting the elastic polymer on a winding roller. This process is conducted in a reel-to-reel manner.

In certain embodiments, as illustrated in FIG. 4, the roll-to-roll process may begin with continuously feeding a solid substrate layer 12 (e.g., PET film) from a feeder roller 10. A dispensing device 14 is operated to dispense and deposit a reactive mass 16 (e.g., slurry) onto the solid substrate layer 12, which is driven toward a pair of rollers (18a, 18b). These rollers are an example of a provision to regulate or control the thickness of the reactive mass 20. The reactive mass 20, supported on the solid substrate, is driven to move through a reacting zone 22 which is provided with a curing means (heat, UV, high energy radiation, etc.). The partially or fully cured polymer 24 is collected on a winding roller 26. One may unwind the roll at a later stage.

The process may further comprise cutting and trimming the layer of elastic polymer into one or multiple pieces of elastic composite separators.

The process may further comprise combining an anode, the elastic polymer separator, an optional working electrolyte, and a cathode electrode to form a lithium battery.

The lithium battery may be a lithium metal battery, lithium-sulfur battery, lithium-selenium battery, lithium-air battery, etc. The cathode active material in the lithium-sulfur battery may comprise sulfur or lithium polysulfide.

### Example 1: Anode-Less Lithium Metal Battery Containing a High-Elasticity Polymer Separator

The ethoxylated trimethylopropane triacrylate monomer (ETPTA, Mw = 428, Sigma-Aldrich) was dissolved in a solvent mixture of ethylene carbonate (EC)/diethyl carbonate (DEC), at a weight-based composition ratio of the ETPTA/solvent of 3/97 (w/w). Subsequently, benzoyl peroxide (BPO, 1.0 wt. % relative to the ETPTA content) as a radical initiator, along with a desired amount of selected lithium salt (e.g., lithium hexafluorophosphate, LiPF₆, or lithium borofluoride, LiBF₄), were added to allow for thermal crosslinking reaction upon deposition on a Cu foil surface. This layer of ETPTA monomer/initiator was then thermally cured at 60° C. for 30 min to obtain an elastomer separator layer.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking. The typical and preferred number of repeat units (Nc) is from 5 to 5,000, more preferably from 10 to 1,000, further preferably from 20 to 500, and most preferably from 50 to 500.

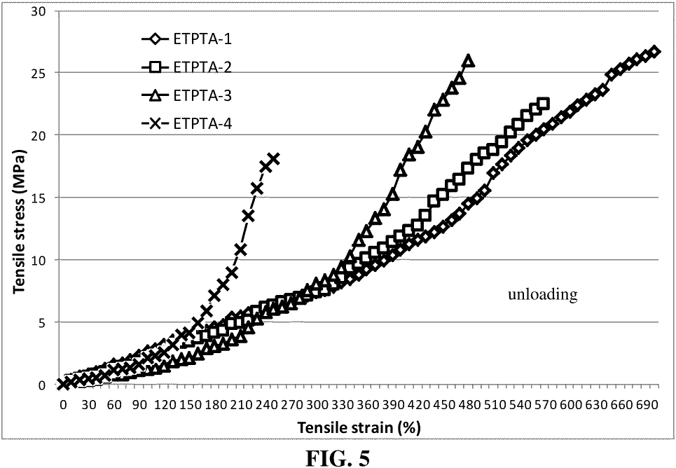

Several tensile testing specimens were cut from each cross-link film and tested with a universal testing machine. The testing results (FIG. 5), indicate that BPO-initiated cross-linked ETPTA polymers have an elastic deformation from approximately 230% to 700%. The above values are for neat polymers without any additive. The addition of up to 30% by weight of an inorganic filler typically reduces this elasticity down to a reversible tensile strain in the range of 10% to 120%.

For electrochemical testing, the working electrodes (cathode layers) were prepared by mixing 85 wt.% LiV₂O₅ or 88% of graphene-embraced LiV₂O₅ particles, 5-8 wt.% CNTs, and 7 wt.% polyvinylidene fluoride (PVDF) binder dissolved in N-methyl-2-pyrrolidinoe (NMP) to form a slurry of 5 wt.% total solid content. After coating the slurries on Al foil, the electrodes were dried at 120° C. in vacuum for 2 h to remove the solvent before pressing. Then, the electrodes were cut into a disk (ϕ = 12 mm) and dried at 100° C. for 24 h in vacuum.

Electrochemical measurements were carried out using CR2032 (3 V) coin-type cells with a sheet of Cu foil as an anode current collector (initially having no lithium metal as the anode active material), an elastic composite separator, and 1 M LiPF₆ electrolyte solution dissolved in a mixture of ethylene carbonate (EC) and diethyl carbonate (DEC) (EC-DEC, 1:1 v/v). Another similarly configured cell was prepared, but using a conventional porous PE/PP separator. The cell assembly was performed in an argon-filled glove-box. The CV measurements were carried out using a CH-6 electrochemical workstation at a scanning rate of 1 mV/s. The electrochemical performance of the cell featuring high-elasticity polymer separator and that containing a conventional plastic separator were evaluated by galvanostatic charge/discharge cycling at a current density of 50 mA/g using an Arbin electrochemical workstation.

The specific intercalation capacity curves of two lithium cells each having a cathode containing LiV₂O₅ particles were measured. As the number of cycles increases, the specific capacity of the cell with a conventional plastic separator drops at a fast rate. In contrast, the presently invented lightly cross-linked ETPTA polymer separator provides the battery cell with a significantly more stable and high specific capacity for a large number of cycles. These data have clearly demonstrated the surprising and superior performance of the presently invented cross-linked ETPTA polymer composite separator approach.

The high-elasticity cross-linked ETPTA polymer separator layer appears to be capable of reversibly deforming to a great extent without breakage when the lithium foil decreases in thickness during battery discharge. The polymer separator layer also prevents the continued reaction between liquid electrolyte and lithium metal at the anode, reducing the problem of continuing loss in lithium and electrolyte. This also enables a significantly more uniform deposition of lithium ions upon returning from the cathode during a battery re-charge; hence, no lithium dendrite. These were observed by using SEM to examine the surfaces of the electrodes recovered from the battery cells after some numbers of charge-discharge cycles.

### Example 2: High-Elasticity Polymer Layer Implemented as The Separator of A Lithium-Licoo₂ Cell (The Cell Being Initially Lithium-Free)

The high-elasticity polymer for making an elastic polymer separator was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into the high elasticity polymer, we chose to use LiPF₆ as an initiator. The ratio between LiPF₆ and the PVA-CN/SN mixture solution was varied from 1/20 to ½ by weight to form a series of precursor solutions. Subsequently, these solutions were separately spray-deposited to form a thin layer of precursor reactive mass onto a Cu foil. The precursor reactive mass was then heated at a temperature from 75 to 100° C. for 2 to 8 hours to obtain a layer of high-elasticity polymer adhered to the Cu foil surface. A NCM-811 based cathode layer supported by an Al foil was then brought to cover the polymer layer to form a cell. Electrochemical testing results show that the cell having an elastic polymer separator layer offers a significantly more stable cycling behavior.

Additionally, some amount of the reacting mass, PVA-CN/LiPF₆, was cast onto a glass surface to form several films which were polymerized and cross-linked to obtain cross-linked polymers having different degrees of cross-linking. Tensile testing was also conducted on these films and this series of cross-linked polymers can be elastically stretched up to approximately 80%.

### Example 3: Li Metal Cells Containing A Petea-Based High-Elasticity Polymer-Protected Anode

For preparing as an elastic composite separator layer, pentaerythritol tetra-acrylate (PETEA), Formula 3, was used as a monomer:

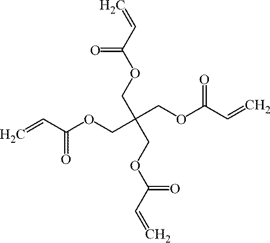 [SMILES: C=CC(=O)OCC(COC(=O)C=C)(COC(=O)C=C)COC(=O)C=C]

In a representative procedure, the precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2- dioxolane (DOL)/dimethoxymethane (DME)(1:1 by volume). The PETEA/AIBN precursor solution, along with a lithium salt (such as lithium borofluoride and LiF) dispersed therein, was cast onto a lithium metal layer pre-deposited on a Cu foil surface to form a precursor film, which was polymerized and cured at 70° C. for half an hour to obtain a lightly cross-linked polymer. This polymer layer was then covered with a cathode electrode.

Commercially available NCM-532 powder (well-known lithium nickel cobalt manganese oxide), along with graphene sheets (as a conductive additive), was then added into an NMP and PVDF binder suspension to form a multiple-component slurry. The slurry was then slurry-coated on Al foil to form cathode layers.

The discharge capacity curves were obtained on two coin cells having the same cathode active material, but one cell having an elastic polymer separator and the other having a conventional porous plastic separator. These results have demonstrated that the elastic polymer separator strategy provides excellent protection against capacity decay of an anode-less lithium metal battery. The high-elasticity polymer separator appears to be capable of reversibly deforming without breakage and maintaining good contacts with the anode when the lithium metal layer expands and shrinks during charge and discharge.

Additionally, the reacting mass, PETEA/AIBN (without any additive), was cast onto a glass surface to form several films that were polymerized and cured to obtain cross-linked polymers having different degrees of cross-linking. Tensile testing was also conducted on these films and this series of cross-linked polymers can be elastically stretched up to approximately 25% (higher degree of cross-linking) to 80% (lower degree of cross-linking).

### Example 4: Li Metal Cells Containing A Sulfonated Triblock Copolymer, Poly(Styrene-Isobutylene-Styrene) Or Sibs, As An Elastic Polymer Separator

Both non-sulfonated and sulfonated elastomer composites were used to build an elastic polymer separator in the anode-less lithium cells. The sulfonated versions typically provide a much higher lithium ion conductivity and, hence, enable higher-rate capability or higher power density. The elastomer matrix can contain a lithium ion-conducting additive, if so desired.

An example of the sulfonation procedure used in this study for making a sulfonated elastomer is summarized as follows: a 10% (w/v) solution of SIBS (50 g) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol % = (moles of sulfonic acid/moles of styrene) × 100%, and the IEC is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). The solution samples were spray-coated on a PET plastic substrate to form free-standing layers of sulfonated elastomer. A layer of elastomer was then sandwich between a lithium metal anode and a cathode electrode.

### Example 5: Elastic Polyurethane Elastomer-Based Solid Electrolyte Separator

Twenty-four parts by weight of diphenylmethane diisocyanate and 22 parts by weight of butylene glycol were continuously reacted with 100 parts by weight of polyethylene adipate having hydroxyl groups at both terminals (molecular weight of 2,100) with agitation at a reaction temperature of 115° C. (along with approximately 32% by weight of LiF and LiTFSI) for a reaction time of 60 minutes to give a prepolymer having hydroxyl-terminal. This prepolymer having hydroxyl-terminal had a viscosity of 4.000 cP at 70° C.

On a separate basis, 84 parts by weight of diphenylmethane diisocyanate was continuously reacted with 200 parts by weight of polyethylene adipate having hydroxyl groups at both terminals (molecular weight of 2,100) with agitation at a reaction temperature of 115° C. for a reaction time of 60 minutes to give a prepolymer having isocyanate-terminal. This prepolymer having isocyanate-terminal had a viscosity of 1,500 cP at 70° C.

One hundred forty-six (146) parts by weight of the thus obtained prepolymer having hydroxyl-terminal and 284 parts by weight of the obtained prepolymer having isocyanate-terminal were continuously injected into a heat exchange reactor and mixed and stirred at a reaction temperature of 190° C. for a residence time of 5-30 minutes. The obtained viscous product was immediately cast onto a glass surface to obtain a layer of elastic polymer having a thickness of approximately 4.1, 12.2, and 20 µm, respectively.

On a separate basis, a sample of reactive polysiloxane (mixed with 5% by wt. of LiF and 5% Li₂CO₃) was cast onto an anode surface and cured at 115° C. for 2 hours to form an elastic polymer film of 8-45 µm in thickness. The lithium ion conductivity of these thin films was approximately 4.5-9.5 10⁻⁵ S/cm.

### Example 6: Polyisoprene Elastomer-Based Solid Electrolyte Separator Layer

A dilute elastomer-solvent solution (0.01-0.1 M of cis-polyisoprene in cyclohexane and 1,4-dioxane) was prepared as a coating solution. Subsequently, lithium hexafluoro phosphate, as a lithium salt, was added and dissolved in the above solution. The solution was then cast over an anode current collector, followed by solvent vaporization to obtain an elastomer-coated anode electrode. A lithium-ion cell was made, comprising the solid-state polymer electrolyte separator-covered Cu foil, a cathode (comprising 75% by weight of LiCoO₂ as the cathode active material, 15% of hybrid particulates, 5% PVDF binder, and 5% combined graphene/CNT as a conductive additive).

### Example 7: Sulfonated Polybutadiene (Pb) Elastomer Separator

Sulfonated PB may be obtained by free radical addition of thiolacetic acid (TAA) followed by in Situ oxidation with performic acid. A representative procedure is given as follows. PB (8.0 g) was dissolved in toluene (800 mL) under vigorous stirring for 72 h at room temperature in a 1 L round-bottom flask. Benzophenone (BZP) (0.225 g; 1.23 mmol; BZP/olefin molar ratio = 1:120) and TAA (11.9 mL; 0.163 mol, TAA/olefin molar ratio = 1.1) were introduced into the reactor and the polymer solution was irradiated for 1 h at room temperature with UV light of 365 nm and power of 100 W.

The resulting thio-acetylated polybutadiene (PB-TA) was isolated by pouring 200 mL of the toluene solution in a plenty of methanol and the polymer recovered by filtration, washed with fresh methanol, and dried in vacuum at room temperature. Formic acid (117 mL; 3.06 mol; HCOOH/olefin molar ratio = 25), along with a desired amount of and a desired amount (0.1%-40% by wt.) of lithium salt (LiPF₆ and lithium trifluoromethanesulfonimide or LiTFSI, respectively), were added to the toluene solution of PB-TA at 50° C. followed by slow addition of 52.6 mL of hydrogen peroxide (35 wt%; 0.61 mol; H₂O₂/olefin molar ratio = 5) in 20 min. We would like to caution that the reaction is autocatalytic and strongly exothermic. The resulting solution was coated onto an anode current collector layer to obtain sulfonated polybutadiene separator-covered anode electrode.

### Example 8: Poly(Butyl Acrylate) Rubber Containing Dinitrile/Litfsi-Based Plastic Crystals Dispersed Therein

For polymerization of PBA rubber, azobisisobutyronitrile (AIBN; 0.5 mol%) and poly(ethylene glycol) diacrylate (PEGDA; 1 mol%) were used as the thermal initiator and cross-linking agent, respectively. In this butyl acrylate (BA) polymerization process, BA/PEGDA produces polymers chemically cross-linked by PEGDA, eventually resulting in elastomer networks. Dinitrile (AND, GLN, and SEN, respectively), in combination with a lithium salt (e.g., LiTFSI), were used to form plastic crystal domains, where the chemical structures of these dinitriles are given below:

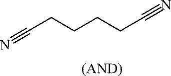

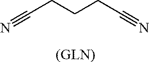

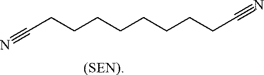

The BA-based solutions were prepared by dissolving 1 mol% PEGDA, 0.5 mol% AIBN, and 1 M LiTFSI powder in BA liquid. The BA-based solutions were polymerized at 70° C. for 2 h to obtain BA-based elastomer with plastic crystal domains dispersed therein. The dinitrile-based solutions were made by mixing a dinitrile with 1 M LiTFSI powder and 5 vol% fluoroethylene carbonate additive at 60° C. to protect against the potential side reaction of dinitrile with Li metal. The two prepared liquid solutions were homogeneously mixed in a volume ratio of 1:1 at 50° C. to produce the elastomer. After dispensing and depositing the prepared solution onto a surface of a cathode active material layer supported on an Al foil current collector, the reactive mass was heated at 70° C. for 2 h to obtain the elastomer layer that is substantially well-bonded to the cathode active layer. For the preparation of an anode-less lithium metal cell, a Cu foil was then covered onto this elastomer layer. For the preparation of a conventional lithium metal cell, the elastomer layer was then covered with a layer of lithium metal foil (20 µm in thickness), which was in turn covered by a Cu foil. The resulting multi-layer structures were then roll-pressed to produce lithium metal cells. In this study, the cathode active layers were prepared from NCM-811 and LFP as cathode active materials, respectively.

### Example 9: Poly(Butyl Acrylate) Rubber Containing Combined Lithium Bis(Oxalato)Borate (Libob)/Dmmp, Dmmemp, and Phosphazene-Based Ion-Conducting Domains

Substantially the same procedure as described in Example 8 was followed, but using lithium bis(oxalato)borate (LiBOB)/DMMP, DMMEMP, and phosphazene as the lithium ion-conducting organic species:

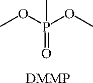

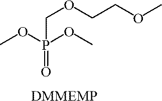

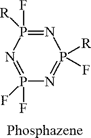

wherein R = H. The lithium ion conductivity of this group of elastic polymer separator layers was found to be from 0.24 × 10⁻³ to 1.6 × 10⁻³ S/cm.

### Example 10: Acrylate Rubber-Based Solid-State Electrolyte Separator

A mixture of monomers is prepared in a first vessel equipped with an agitator. The mixture contains 96 parts of ethyl acrylate, 1 part of methacrylic acid, 3 parts of vinyl chloroacetate and 0.01 parts of t-dodecyl mercaptan. In a second vessel, an emulsifying mixture is prepared containing 275 parts of demineralized water pre-heated at 70° C. 3.2 parts of sodium lauryl sulfate, 1.1 parts of a polymeric condensate of β-naphthalene sulphonic acid and 0.7 parts of sodium bicarbonate. In a third vessel, an initiator solution is prepared with 70 parts of water and 0.45 parts of potassium persulfate.

A polymerization reactor is repeatedly filled and purged with nitrogen gas for the purpose of eliminating any trace of oxygen. The pre-heated emulsifying mixture is then fed into the reactor, which is followed by the addition of 60% of the initiator batch. The reactor temperature is adjusted to 50° C. and the continuous and uniform feeding of the reaction mixture (monomers mixed with the chain transfer agent) starts, drop by drop, during a period of six hours. During the third hour of the reaction, the remaining 40% of the initiator solution is added. When the mixture is totally consumed, the reaction is completed. After the end of the reaction, the rubber latex or the acrylic elastomer is coagulated by the addition of excessive calcium chloride. The rubber is washed and dried at around 65° C.,

Solvents that can be used to dissolve the polyacrylic latex include methylethyl ketone, toluene, xylene, or benzene.

In conclusion, the high-elasticity polymer-based separator strategy is surprisingly effective in alleviating the problems of lithium metal dendrite formation and lithium metal-electrolyte reactions that otherwise lead to rapid capacity decay and potentially internal shorting and explosion of the lithium secondary batteries. The high-elasticity polymer composite is capable of expanding or shrinking congruently or conformably with the anode layer. This capability helps to maintain a good contact between the current collector (or the deposited lithium film during the charging procedure) and the separator, enabling uniform re-deposition of lithium ions without interruption.

We claim:

1. A lithium metal battery comprising a cathode, an anode, and an elastic polymer separator disposed between said cathode and said anode, wherein said elastic polymer separator comprises a high-elasticity polymer and said elastic polymer separator has a thickness from 50 nm to 100 µm and a lithium ion conductivity from 10⁻⁶ S/cm to 5 × 10⁻² S/cm at room temperature and said high elasticity polymer has a fully recoverable tensile strain from 2% to 1,000% when measured without any additive dispersed therein.

2. The lithium metal battery of claim 1, wherein the anode has an anode current collector but initially the anode has no lithium or lithium alloy as an anode active material supported by said anode current collector when the battery is made and prior to a charge or discharge operation of the battery.

3. The lithium metal battery of claim 1, wherein the anode has an anode current collector and an amount of lithium or lithium alloy as an anode active material supported by said anode current collector.

4. The lithium metal battery of claim 1, wherein said high-elasticity polymer comprises an elastomer or rubber selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof, and wherein the lithium metal battery does not include lithium-sulfur battery or lithium-selenium battery.

5. The lithium metal battery of claim 1, wherein the high-elasticity polymer contains a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, in the cross-linked network of polymer chains having a degree of crosslinking that affords an elasticity of the polymer in the range from 5% to 1,000%.

6. The lithium metal battery of claim 1, wherein said elastic polymer separator further comprises from 0.1% to 70% by weight of a lithium ion-conducting material dispersed or dissolved in the high-elasticity polymer.

7. The lithium metal battery of claim 6, wherein said lithium ion-conducting material comprises a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

8. The lithium metal battery of claim 6, wherein said lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X = F, Cl, I, or Br, R = a hydrocarbon group, x = 0-1, y = 1-4.

9. The lithium metal battery of claim 1, wherein the high-elasticity polymer forms a mixture, blend, copolymer, crosslinked network, or interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

10. The lithium metal battery of claim 1, wherein the high-elasticity polymer comprises from 5% to 95% by weight of a lithium ion-conducting plastic crystal or organic domain phase dispersed in or connected to the high-elasticity polymer.

11. The lithium metal battery of claim 10, wherein the high-elasticity polymer and the plastic crystal or organic domain phase form co-continuous phases exhibiting a lithium-ion conductivity no less than 10⁻⁵ S/cm.

12. The lithium metal battery of claim 10, wherein the plastic crystal or organic domain phase comprises a mixture of a lithium salt and a lithium ion conducting organic species selected from a fluorinated carbonate, hydrofluoroether, fluorinated vinyl carbonate, fluorinated ester, fluorinated vinyl ester, fluorinated vinyl ether, sulfone, sulfide, nitrile, phosphate, phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, fluoroethylene carbonate (FEC), an ionic liquid solvent, a polymerized version thereof, or a combination thereof.

13. The lithium metal battery of claim 12, wherein the polymerized version of the organic species has a molecular weight less than 10,000 g/mole.

14. The lithium metal battery of claim 10, wherein:
the plastic crystal or organic domain phase comprises a mixture of a lithium salt and a lithium ion conducting organic species selected from a fluorinated carbonate, hydrofluoroether, fluorinated vinyl carbonate, fluorinated ester, fluorinated vinyl ester, fluorinated vinyl ether, sulfone, sulfide, nitrile, succinonitrile, phosphate, phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, fluoroethylene carbonate (FEC), an ionic liquid solvent, or a combination thereof; and
the high-elasticity polymer comprises an elastomer or rubber selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

15. The lithium metal battery of claim 12, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof: 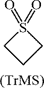 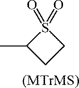 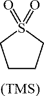 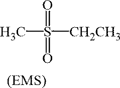 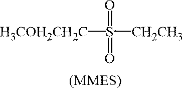 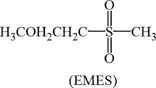 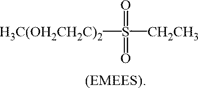
.

16. The lithium metal battery of claim 15, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

17. The lithium metal battery of claim 12, wherein the nitrile comprises a dinitrile or is selected from AND, GLN, SEN, a combination thereof, or a combination thereof with succino-nitrile: 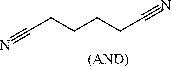 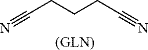 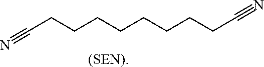
.

18. The lithium metal battery of claim 12, wherein the phosphate is selected from allyl-type, vinyl-type, styrenic-type and (meth)acrylic-type monomers bearing a phosphonate moiety.

19. The lithium metal battery of claim 12, wherein the phosphate, phosphonate, phosphonic acid, phosphazene, or phosphite is selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 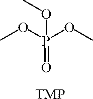 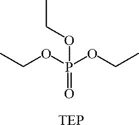 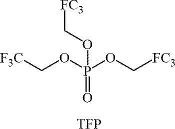 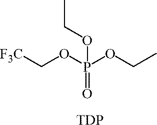 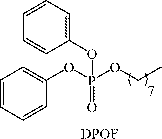 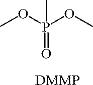 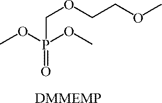 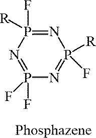
wherein R = H, NH₂, or C₁-C₆ alkyl.

20. The lithium metal battery of claim 12, wherein the siloxane or silane is selected from alkylsiloxane (Si—O), alkyylsilane (Si—C), liquid oligomeric silaxane (—Si—O—Si—), or a combination thereof.

21. The lithium metal battery of claim 1, wherein the high-elasticity polymer further contains a reinforcement material dispersed therein wherein the reinforcement material is selected from a polymer fiber, a glass fiber, a ceramic fiber, a nano-flake, or a combination thereof.

22. The lithium metal battery of claim 1, wherein said battery further comprises, in addition to the elastic polymer separator serving as a solid electrolyte, a working electrolyte in ionic contact with an anode active material and/or a cathode active material wherein said working electrolyte is selected from an organic liquid electrolyte, ionic liquid electrolyte, polymer gel electrolyte, solid polymer electrolyte different than the high-elasticity polymer in composition or structure, inorganic solid electrolyte, quasi-solid electrolyte having a lithium salt dissolved in an organic or ionic liquid with a lithium salt concentration higher than 2.0 M, or a combination thereof.

23. The lithium metal battery of claim 1, wherein said cathode comprises a cathode active material selected from an inorganic material, an organic material, a polymeric material, or a combination thereof.

24. The lithium metal battery of claim 23, wherein said inorganic material, as a cathode active material, is selected from a metal oxide, metal phosphate, metal silicide, metal selenide, transition metal sulfide, or a combination thereof.

25. The lithium metal battery of claim 23, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

26. The lithium metal battery of claim 23, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x + y ≤ 1.

27. The lithium metal battery of claim 1, wherein the cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

28. The lithium metal battery of claim 24, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

29. A process for manufacturing the elastic polymer separator of claim 1, the process comprising (A) providing (i) a liquid polymer solution comprising a high-elasticity polymer dissolved in a liquid solvent or (ii) a liquid reactive mass as a precursor to a high-elasticity polymer; (B) dispensing and depositing a layer of the liquid solution or the liquid reactive mass onto a solid substrate surface; and (C) removing the liquid solvent from the liquid polymer solution to precipitate out the high-elasticity polymer or polymerizing and/or curing the reactive mass to form the layer of elastic polymer separator.

30. The process of claim 29, wherein said solid substrate is an anode current collector, an anode active material layer, or a cathode active material layer.

31. The process of claim 29, wherein the liquid polymer solution or the liquid reactive mass comprises a lithium salt and/or a lithium ion-conducting material dissolved or dispersed therein.

32. The process of claim 29, which is a roll-to-roll process wherein said step (B) comprises (1) continuously feeding a layer of the solid substrate from a feeder roller to a dispensing zone where the liquid polymer solution or the reactive mass is dispensed and deposited onto the solid substrate to form a continuous layer of the liquid polymer solution or the reactive mass; (2) moving the layer of the liquid polymer solution or the reactive mass into a reacting zone where the liquid polymer solution or the reactive mass is subjected to solvent removal or exposed to heat, ultraviolet light, or high-energy radiation to polymerize and/or cure the reactive mass to form a continuous layer of elastic polymer; and (3) collecting the elastic polymer on a winding roller.

33. The process of claim 32, further comprising cutting and trimming said layer of elastic polymer into one or multiple pieces of elastic polymer separators.

34. The process of claim 29, further comprising a step of combining an anode, said elastic polymer separator, and a cathode electrode to form a lithium battery cell.

35. The process of claim 35, wherein a working electrolyte is also combined with said anode, said elastic polymer separator, and said cathode electrode to form said lithium battery cell.
